(19) United States
(12) Patent Application Publication
(10) Pub. No.: US 2012/0063830 A1
(43) Pub. Date: Mar. 15, 2012

(54) IMAGE FORMING APPARATUS AND CONTROL METHOD THEREOF

(75) Inventors: Hyun-soo Song, Suwon-si (KR); Hyou-Jin Kim, Anyang-si (KR)

(73) Assignee: Samsung Electronics Co., Ltd., Suwon-si (KR)

(21) Appl. No.: 13/016,324

(22) Filed: Jan. 28, 2011

(30) Foreign Application Priority Data
Sep. 15, 2010 (KR) 10-2010-0090419

(51) Int. Cl. G03G 15/00

(52) U.S. Cl. 399/407

(57) ABSTRACT

The post-processing device which performs a post-processing operation for a discharged printing medium with an image formed thereon, includes: an image forming unit which forms an image on the printing medium; a medium feeding unit which feeds the printing medium to the image forming unit; a discharging unit which is provided in the post-processing device and discharges the printing medium with the image formed thereon; a medium alignment unit which aligns the printing medium for post-processing for the discharged printing medium; a user interface unit which receives an instruction form a user; and a control unit which controls a width of the medium alignment unit to correspond to a width of the discharged printing medium based on a setting value for the medium feeding unit, which is input through the user interface unit, when the size of the printing medium loaded on the medium feeding unit is not detected. With this configuration, it is possible to control a width of a medium alignment unit for post-processing using a setting value set for a multipurpose cassette having no size sensor, so that printing media having different sizes can be properly aligned.

### CROSS-REFERENCE TO RELATED APPLICATIONS

This application claims priority benefit from Korean Patent Application No. 10-2010-0090419, filed on Sep. 15, 2010 in the Korean Intellectual Property Office, the disclosure of which is incorporated herein by reference.

### BACKGROUND

1. Field

Apparatuses and methods consistent with the exemplary embodiments relate to an image forming apparatus and a control method thereof, and more particularly, to an image forming apparatus which performs post-processing for a printing medium, and a control method thereof.

2. Description of the Related Art

An image forming apparatus forms an image to be printed on a recording medium. The image forming apparatus may be implemented by a printer, a copier, a facsimile, a multifunction copier having two or more functions, or any other known in the art.

In recent years, image forming apparatuses as office automation equipment such as a multifunction copier which performs a printing function of outputting a document as well as functions of a scanner and a facsimile have been in increasing demand. Such image forming apparatuses have a tendency of development toward high performance for expansion of their own functions to be performed.

Thus, a post-processing device (for example, an output device or a finisher) for performing post-processing for a printing medium which has been printed may be connected to or incorporated in an image forming apparatus.

A post-processing device is a device which performs binding, folding, stapling, punching and the like for a printed medium. As used herein, ‘binding’ refers to bookbinding of printing media with a portion of the media pasted or the like, ‘folding’ refers to folding a portion of printing media, ‘stapling’ refers to tying printing media using a staple, and ‘punching’ refers to punching a portion of printing media.

Upon receiving a print instruction including a post-processing option, the image forming apparatus forms an image on a printing medium and conveys the printing medium with the image formed thereon to a discharging portion of a post-processing device and then discharges the printing medium.

The post-processing device may include a media alignment portion for aligning discharged printing media and a stacker which stacks the printing media aligned by the media alignment portion. The post-processing device performs post-processing for the printing media stacked on the stacker.

The media alignment portion is a pair of temper members which are spaced by a predetermined distance from each other. In order to facilitate the post-processing, there is a need to control the distance, i.e., width, between the pair of temper members to correspond to a width of a discharged printing medium depending on the kind, i.e., size of the printing medium.

Thus, the image forming apparatus detects the size of the printing medium and controls the width of the temper members to correspond to the detected size.

Examples of methods of detecting the size of the printing medium may include a method of using a size sensor provided in a paper feeding tray, a method of using time detected by a sensor which is placed on a conveying path of the printing medium and recognizes progress of the printing medium, etc.

However, there is a limit to recognition of all kinds of papers with the sensor placed on the conveying path. In typical, since a multipurpose cassette does not have a sensor which senses a size of a printing medium directly, it is difficult to detect correct size information.

For example, upon receiving a print instruction including a post-processing option for an A5 medium loaded on a multipurpose cassette having no size sensor, the image forming apparatus sets a width of tempers to correspond to the largest medium size, i.e., Legal size, since it can not detect medium size information.

Accordingly, since the tempers perform alignment under the condition where a medium is set to be larger than an actual size of medium, printing media stacked in the stacker are not properly aligned, which makes post-processing for the printing media difficult.

In particular, even when a sensor is placed on the conveying path of the printing medium, since a first printing medium is stacked on the stacker before the image forming apparatus detects a sensing value, the printing media may not be properly aligned.

### SUMMARY

Accordingly, one or more exemplary embodiments provide an image forming apparatus which is capable of performing a post-processing operation with ease by controlling a width of a medium alignment unit for post-processing using a setting value set for a multipurpose cassette having no size sensor, so that printing media having different sizes can be properly aligned, and a control method thereof.

Another exemplary embodiment is to provide an image forming apparatus which is capable of properly controlling a width of a medium alignment unit even for a first printing medium which can not use a sensing value of a sensor placed on a conveying path, depending on the size of printing medium, and a control method thereof.

The foregoing and/or other aspects may be achieved by providing an image forming apparatus including a post-processing device which performs a post-processing operation for a discharged printing medium with an image formed thereon, including: an image forming unit which forms an image on the printing medium; a medium feeding unit which feeds the printing medium to the image forming unit; a discharging unit which is provided in the post-processing device and discharges the printing medium with the image formed thereon; a medium alignment unit which aligns the printing medium for post-processing for the discharged printing medium; a user interface unit which receives an instruction from a user; and a control unit which controls a width of the medium alignment unit to correspond to a width of the discharged printing medium based on a setting value for the medium feeding unit, which is input through the user interface unit, when the size of the printing medium loaded on the medium feeding unit is not detected.

The medium alignment unit may include a pair of tempers which are spaced by a predetermined distance from each other, and the control unit may control the width between the pair of tempers based on a setting value for the type of printing medium for the medium feeding unit, which is input through the user interface unit.

The image forming apparatus may further include a conveying unit which conveys the printing medium fed from the medium feeding unit and includes a sensor which detects the conveyed printing medium, and the control unit may control the width of the medium alignment unit using a sensing value of the sensor.

The control unit may control the width of the medium alignment unit for second and subsequent printing media using the sensing value of the sensor which is detected for a first printing medium of a plurality of printing media.

The medium feeding unit may include a multipurpose cassette.

The foregoing and/or other aspects may be achieved by providing an image forming apparatus which can be connected to a post-processing device which performs a post-processing operation for a discharged printing medium with an image formed thereon and includes a discharging unit which discharges the printing medium with the image formed thereon and a medium alignment unit which aligns the printing medium for post-processing for the discharged printing medium, including: a communication unit which performs communication with the post-processing device; an image forming unit which forms an image on the printing medium; a medium feeding unit which feeds the printing medium to the image forming unit; a user interface unit which receives an instruction from a user; and a control unit which controls the communication unit to transmit an instruction to control a width of the medium alignment unit to correspond to a width of the printing medium discharged through the post-processing device to the post-processing device based on a setting value for the medium feeding unit, which is input through the user interface unit, when the size of the printing medium loaded on the medium feeding unit is not detected.

The foregoing and/or other aspects may be achieved by providing an image forming apparatus which is connected to a host device and includes a post-processing device which performs a post-processing operation for a discharged printing medium with an image formed thereon, including: an image forming unit which forms an image on the printing medium; a medium feeding unit which feeds the printing medium to the image forming unit; a discharging unit which is provided in the post-processing device and discharges the printing medium with the image formed thereon; a medium alignment unit which aligns the printing medium for post-processing for the discharged printing medium; a communication unit which receives a setting value for the medium feeding unit from the host device; and a control unit which controls a width of the medium alignment unit to correspond to a width of the discharged printing medium based on the setting value for the medium feeding unit, which is received through the communication unit, when the size of the printing medium loaded on the medium feeding unit is not detected.

The foregoing and/or other aspects may be achieved by providing an image forming apparatus which can be connected to a host device and a post-processing device which performs a post-processing operation for a discharged printing medium with an image formed thereon and includes a discharging unit which discharges the printing medium with the image formed thereon and a medium alignment unit which aligns the printing medium for post-processing for the discharged printing medium, including: an image forming unit which forms an image on the printing medium; a medium feeding unit which feeds the printing medium to the image forming unit; a communication unit which performs communication with the post-processing device and the host device and receives a setting value for the medium feeding unit from the host device; and a control unit which controls the communication unit to transmit an instruction to control a width of the medium alignment unit to correspond to a width of the printing medium discharged through the post-processing device to the post-processing device based on the setting value for the medium feeding unit, which is received through the communication, when the size of the printing medium loaded on the medium feeding unit is not detected.

The foregoing and/or other aspects may be achieved by providing a control method of an image forming apparatus which performs a post-processing operation for a discharged printing medium with an image formed thereon and includes a medium alignment unit which aligns the printing medium for post-processing for the discharged printing medium, including: inputting a setting value for a medium feeding unit which feeds a printing medium; receiving a print instruction including a post-processing option; and controlling a width of the medium alignment unit to correspond to a width of the discharged printing medium with the image formed thereon based on the setting value for the medium feeding unit, when the size of the printing medium loaded on the medium feeding unit is not detected.

The inputting a setting value for a medium feeding unit may include using one of a user interface unit provided in the image forming apparatus and an input unit of a host device which can be connected to the image forming apparatus.

The medium alignment may include a pair of tempers which are spaced by a predetermined distance from each other, the inputting a setting value for a medium feeding unit may include inputting a setting value for the type of printing medium for the medium feeding unit, and the controlling a width of the medium alignment unit may include controlling the width between the pair of tempers based on the input setting value.

The control method may further include: detecting a first printing medium of a plurality of printing media through a sensor placed on a conveying path of the printing medium; and controlling the width of the medium alignment unit for second and subsequent printing media using the detected sensing value.

According to the exemplary embodiments of the present invention, the image forming apparatus and the control method thereof are capable of performing a post-processing operation with ease by controlling a width of a medium alignment unit for post-processing using a setting value set for a multipurpose cassette having no size sensor, so that printing media having different sizes can be properly aligned and narrow printing media can be prevented from being dropped without alignment

In particular, the image forming apparatus and the control method thereof are capable of properly controlling a width of a medium alignment unit even for a first printing medium which can not use a sensing value of a sensor placed on a conveying path, depending on the size of printing medium.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a side view showing an image forming apparatus and a post-processing device according to one exemplary embodiment;

FIG. 2 is a front view showing an image forming apparatus and a post-processing device according to one exemplary embodiment;

FIG. 3 is a block diagram showing a configuration of an image forming system including an image forming apparatus according to one exemplary embodiment;

FIG. 4 is a view showing one example of an image forming apparatus having a user interface; and

FIGS. 5A and 5B are flow charts showing a control method of an image forming apparatus according to one exemplary embodiment.

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

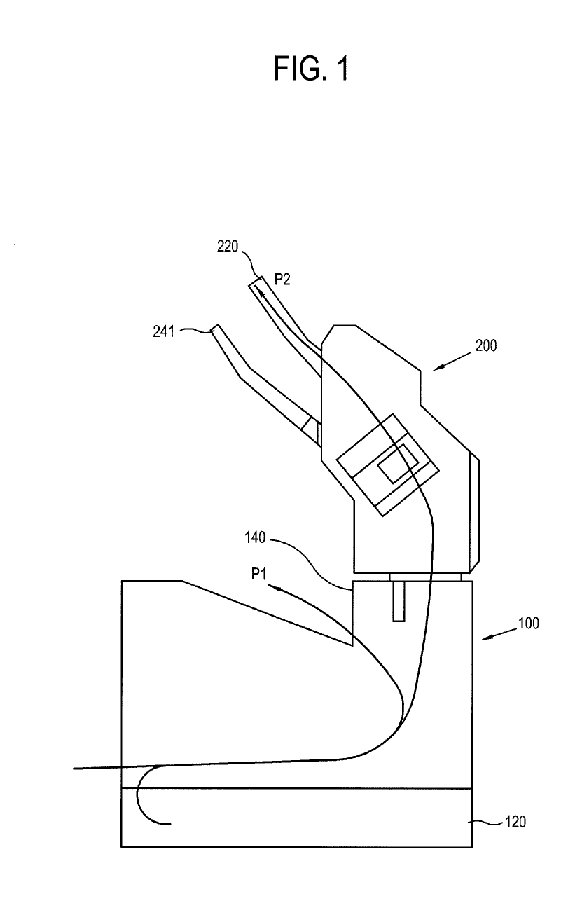

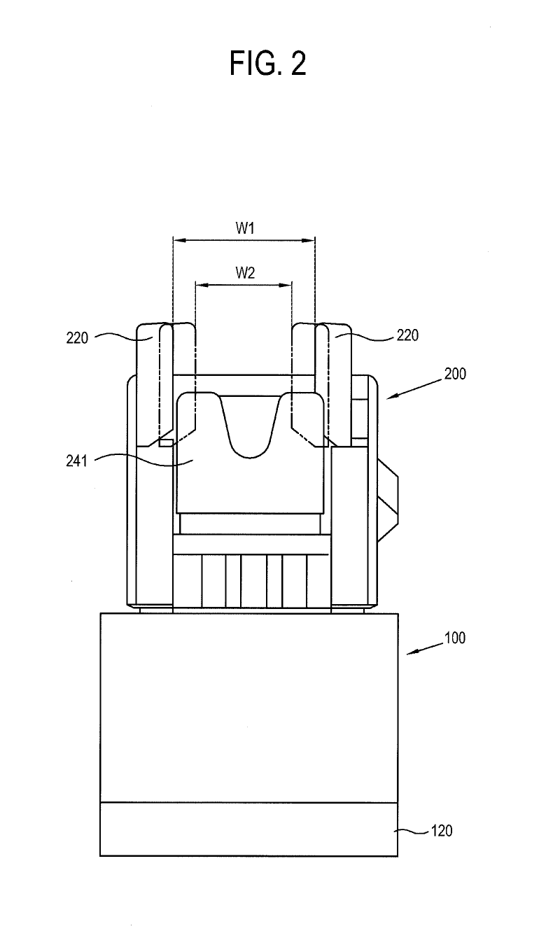

FIGS. 1 and 2 are a side view and a front view showing an image forming apparatus 100 and a post-processing device 200, respectively, according to one exemplary embodiment.

In this embodiment, the image forming apparatus 100 may be implemented by a printer, a copier, a facsimile, a multifunction copier having two or more functions, however, it is not limited thereto.

In this embodiment, a post-processing device 200 (for example, an output device or a finisher) for performing post-processing for a printing medium which has been printed may be connected to the image forming apparatus 100.

The post-processing device 200 is a kind of optional device and may be connected to the image forming apparatus 100 via a communication interface channel such as a universal asynchronous receiver transmitter (UART), a universal serial bus (USB) wired, wireless, or optical network.

As shown in FIGS. 1 and 2, the post-processing device 200 is combined to one side, for example, the top, of the image forming apparatus 100 and performs post-processing for a discharged printing medium having an image formed thereon.

Upon receiving a print instruction including a post-processing option, the image forming apparatus 100 conveys a printing medium fed from a medium feeding unit 120 to a second discharging unit 240, which is provided in the post-processing device 200 and discharges the conveyed printing medium, along a conveying path P2 within the post-processing device 200 through a conveying path within the image forming apparatus 100.

If the print instruction includes no post-processing option, the image forming apparatus 100 conveys the printing medium to a first discharging unit 140, which is provided in the image forming apparatus 100 and discharges the conveyed printing medium, via a conveying path P1.

Although it is illustrated in FIGS. 1 and 2 that a separate post-processing device 200 is combined to one side of the image forming apparatus 100, the post-processing device 200 may be incorporated into the image forming apparatus 100, as one element thereof.

Although an exemplary embodiment of the post-processing device 200 provided as a separate device will be described in the following description, it should be understood that the present invention includes both a case where the image forming apparatus 100 and the separate post-processing device 200 are interconnected via a communication interface and a case where the post-processing device is incorporated into the image forming apparatus 100.

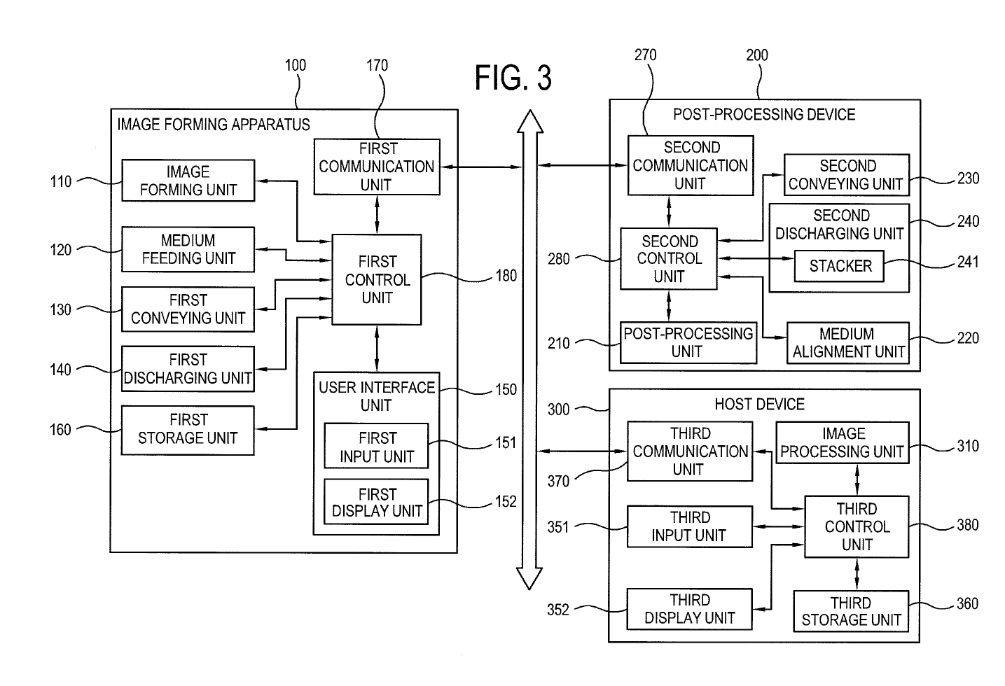

FIG. 3 is a block diagram showing a configuration of an image forming system including the image forming apparatus 100 according to one exemplary embodiment.

As shown in FIG. 3, the image forming apparatus 100 includes an image forming unit 110, a medium feeding unit 120, a first conveying unit 130, a first discharging unit 140, a user interface (UI) unit 150, a first storage unit 160, a first communication unit 170 and a first control unit 180. The user interface unit 150 may include a first input unit 151 and a first display unit 152.

Upon receiving a print instruction, the image forming unit 110 forms an image to be printed on at least one printing medium (paper) based on print data. As used herein, the term ‘printing’ includes printing for copy after a manuscript is scanned, printing of received fax data, printing of print data received externally via a host device 300 including a server or print data stored in an internal memory (for example, HDD) or an external memory (for example, USB memory) of the image forming apparatus 100, etc. In this embodiment, the image forming unit 110 may include a development unit including an image receptor, an optical scanning unit, a transfer unit and/or a fixing unit.

The image forming apparatus 100 may include a monochromatic image forming apparatus which forms an image by means of the image forming unit 110 using a monochromatic developer (typically black), a color image forming apparatus which forms a color image using a four-color developer, and a multi-color image forming apparatus which forms a color image using an auxiliary developer such as a white developer in addition to the four-color developer.

The medium feeding unit 120 feeds printing media into the image forming unit 110 and includes at least one paper feeding tray on which the printing media are loaded. The medium feeding unit 120 includes an automatic document feeder (ADF) or a duplex automatic document feeder (DADF) depending on a method of feeding printing media and may further include a pick-up roller which picks up the printing media loaded on the paper feeding tray. The paper feeding tray includes at least one of a paper feeding cassette, a manual paper feeding tray and an optional tray.

Here, the paper feeding tray includes a multipurpose cassette on which printing media of different sizes (for example, A4, A5, B4, Letter, Legal, etc.) can be loaded. In this embodiment, the multipurpose cassette does not have a sensor which senses sizes of the printing media.

The first conveying unit 130 includes a conveying belt which conveys a printing medium fed from the medium feeding unit 120 through the image forming unit 110.

If a print instruction does not include a post-processing option, the first conveying unit 130 conveys the printing medium through the conveying path P1 shown in FIG. 1 under control of the first control unit 180. The conveyed printing medium is discharged through the first discharging unit 140.

If the print instruction includes the post-processing option, the first conveying unit 130 conveys the printing medium fed from the medium feeding unit 120 to the conveying path P2 of the post-processing device 200 via the conveying path of the image forming apparatus 100 shown in FIG. 1 under control of the first control unit 180. The post-processing device 200 conveys the printing medium conveyed from the image forming apparatus 100 through the conveying path P2, and then discharges the printing medium to a second discharging unit 240.

The first conveying unit 130 may further include a sensor which is placed on the conveying path of the printing medium and recognizes progress of the printing medium. The first control unit 180 acquires length information of the printing medium using time detected by the sensor and may infer width information of the printing medium using the acquired length information.

The inferred width information of the printing medium may be used to control a width of a medium alignment unit 220 for second and subsequent printing media in performing a printing operation including a post-processing option, which will be described later.

The first discharging unit 140 includes a discharging roller (not shown) which discharges the printing medium with an image formed thereon out of the image forming apparatus 100, and a bin (not shown) which accommodates the discharged printing medium.

The user interface unit 150 receives an instruction from a user and displays a result obtained based on the instruction.

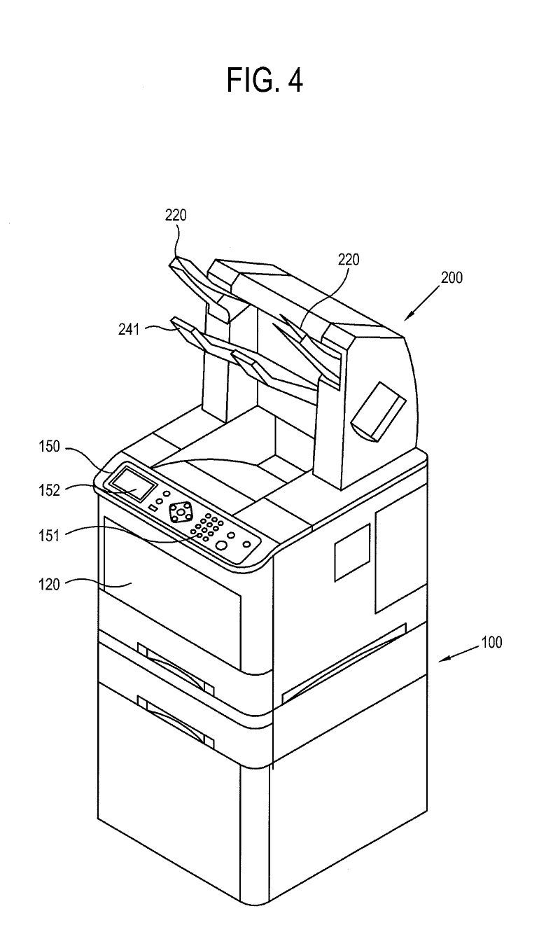

FIG. 4 is a view showing one example of the image forming apparatus 100 having the user interface unit 150.

As shown in FIG. 4, the user interface unit 150 may include a first input unit 151 which receives an instruction from a user, and a first display unit 152 which displays setting and operation states of the image forming apparatus 100 to the user.

The first input unit 151 includes key buttons provided in the image forming apparatus 100 (hereinafter referred also to as “hard keys” or “keypad”), and a graphics user interface (GUI) which is generated by execution of a predetermined application and is displayed in the first display unit 152 to allow the user to input instructions by touch and the like.

The first display unit 152 may include a liquid crystal display (LCD) panel and a driver which drives the LCD panel.

The user may perform a setting operation for the medium feeding unit 120 using the user interface unit 150.

For example, if the medium feeding unit 120 includes a multipurpose cassette as a paper feeding tray, the user may manipulate the UI unit 150 to input a setting value (for example, A4) to set the type of printing media loaded on the multipurpose cassette.

The first control unit 180 generates an instruction to control the medium alignment unit 220 of the post-processing device 200 based on the setting value input through the UI unit 150 and controls the first communication unit 170 to transmit the generated instruction to the post-processing device 200.

If the post-processing device 200 is incorporated into the image forming apparatus 100, the first control unit 180 controls the medium alignment unit 220 of the post-processing device 200 based on the setting value input through the UI unit 150.

The user may perform a log-in procedure to input his/her assigned ID and password through the user interface unit 150. Here, the log-in includes a log-in of an administrator mode which may be set and modified for all configurations of the image forming apparatus without separate access restriction. When the user's log-in or administrator mode log-in procedure is performed, the image forming apparatus 100 performs an identification and authentication procedure for this log-in.

In some case, the image forming apparatus 100 may not include the UI unit 150. For example, an inexpensive model of image forming apparatus 100 may not include the UI unit 150 including an LCD panel.

If the image forming apparatus 100 does not include the user interface unit 150, the first control unit 180 may generate an instruction to control the medium alignment unit 220 using a setting value set for the medium feeding unit 120 using a host device 300 which will be described later.

The setting value set through the user interface unit 150 as described above is stored in the first storage unit 160.

The first storage unit 160 may further store a variety of information such as print data received from the outside, facsimile data, scan images generated by a scanning unit, user registration information set for each user account, user authentication information, user authorization information and so on in addition to various setting values of the image forming apparatus 100.

Examples of the first storage unit 160 may include an internal storage medium such as HDD, and an external or portable storage medium such as a USB memory and a memory card (memory stick, CF card, MMC, etc.).

The first communication unit 170 performs communication with an external device including the post-processing device 200 and the host device 300.

Specifically, the first communication unit 170 transmits an instruction to control the width of the medium alignment unit 220, which is set based on the setting value for the medium feeding unit 120 set through the user interface unit 150, to the post-processing device 200.

In addition, the first communication unit 170 may receive a setting value for the medium feeding unit 120 set through the host device 300, which will be described later, and transmit an instruction to control the width of the medium alignment unit 220 generated in response to the received setting value to the post-processing unit 200.

Examples of the first communication unit 170 may include a wired and/or wireless communication module which can be connected to the external device such as the post-processing unit 200 and the host device 300 by network using a predetermined protocol, a communication interface such as a universal asynchronous receiver transmitter (UART) or a universal serial bus (USB), however, it is not limited thereto.

Upon receiving a print instruction, the first control unit 180 controls the image forming unit 110 to receive a printing medium from the medium feeding unit 120 and form an image on the printing medium, and controls the first conveying unit 130 to convey the printing medium with the image formed thereon.

If the received print instruction includes a post-processing option, the first control unit 180 controls the conveying path of the first conveying unit 130 such that the printing medium can be discharged to the post-processing device 200, and, based on the setting value for the medium feeding unit 120 input through the user interface unit 150, generates an instruction to control the width of the medium alignment unit to correspond to the width of the printing medium discharged through the second discharging unit 240 of the post-processing device 200.

In addition, the first control unit 180 controls the first communication unit 170 to transmit the generated instruction to the post-processing device 200. In this embodiment, the first control unit 180 may control the first communication unit 170 to transmit a print instruction including a post-processing option to the post-processing device 200.

The post-processing device 200 performs post-processing for the printing medium received from the first conveying unit 130 of the image forming apparatus 100.

In the meantime, the first control unit 180 may control the width of the medium alignment unit 220 using the setting value set through the user interface unit 150 for only the first discharged printing medium and use time information detected by a sensor, which is placed on the conveying path of the image forming apparatus 100 and recognizes the progress of the printing medium, for the second and subsequent printing media.

Specifically, the first control unit 180 may acquire length information of the printing medium using the time information acquired while the first printing medium is being conveyed, infer width information of the printing medium using the acquired length information, and generate an instruction to control the width of the medium alignment unit 220 to correspond to the inferred width information.

In this embodiment, the inferred printing medium width information may be equal to a setting value set through the user interface unit 150.

As shown in FIG. 3, the post-processing device 200 includes a post-processing unit 210, a medium alignment unit 220, a second conveying unit 230, a second discharging unit 240, a second communication unit 270 and a second control unit 280.

The post-processing unit 210 performs a predetermined post-processing operation for a printed printing medium. As used herein, the term ‘post-processing’ includes ‘binding’ referring bookbinding of printing media with a portion of the media pasted or the like, ‘folding’ referring to folding a portion of printing media, ‘stapling’ referring to tying printing media using a staple, and ‘punching’ referring to punching a portion of printing media.

The medium alignment unit 220 is a pair of temper members which are spaced by a predetermined distance from each other and aligns printing media discharged while being move from side to side to facilitate a post-processing operation. That is, the medium alignment unit 220 has a structure where the tempers temporarily load and cool printed and discharged printing media, guide and align the side of the predetermined number of printing media accumulated in the tempers, and put the aligned printing media on a stacker 241 at the bottom of the tempers.

In this embodiment, in the medium alignment unit 220, the distance, i.e., width, between the pair of temper members is controlled to correspond to a width of the discharged printing medium depending on the kind, i.e., size of the printing medium.

For example, referring to FIG. 2, the width of the medium alignment unit 220 may be set to be wider (w1) if a printing medium is a Legal paper and set to be narrower (w2) if the printing medium is an A5 paper.

The post-processing device 200 adjusts the width of the medium alignment unit 220 to correspond to a width of printing media of different types under control of the second control unit 280.

The second conveying unit 230 includes a conveying belt (not shown) to convey the printing medium received from the first conveying unit 130 of the image forming apparatus 100. In this embodiment, the second conveying unit 230 conveys the printing medium along the conveying path P2 shown in FIG. 1.

The second discharging unit 240 includes a discharging roller (not shown) which discharges the printing medium with an image formed thereon for post-processing, a bin (not shown) which accommodates the discharged printing medium, and a stacker 241 on which printing media aligned by the medium alignment unit 220 are stacked.

In this embodiment, the printing media stacked on the stacker 241 are aligned by the medium alignment unit 220 to facilitate a post-processing operation.

The second communication unit 270 performs data communication with the image forming apparatus 100. Specifically, the second communication unit 270 receives an instruction to control the width of the medium alignment unit 220 from the image forming apparatus.

Examples of the second communication unit 270 may include a communication interface such as a universal asynchronous receiver transmitter (UART) or a universal serial bus (USB) which can be connected to the image forming apparatus 100.

Upon receiving a print instruction including a post-processing option from the image forming apparatus 100 via the second communication unit 270, the second control unit 280 controls the second conveying unit 230 to convey the printing medium received from the first conveying unit 130 of the image forming apparatus 100 along the conveying path P2 and controls the second discharging unit 240 to discharge the conveyed printing medium.

Upon receiving the instruction to control the width of the medium alignment unit 220 from the image forming apparatus, the second control unit 280 controls the width of the medium alignment unit 220 to correspond to the width of the discharged printing medium according to the received instruction.

In this embodiment, the received instruction to control the width of the medium alignment unit 220 may be determined by a setting value for the medium feeding unit 120 set by the user interface unit 150 for the first printing medium and may be determined by information inferred through the sensor placed on the conveying path of the image forming apparatus 100 for the second and subsequent printing media.

In this embodiment, if the printing medium information inferred through the sensor placed on the conveying path of the image forming apparatus 200 does not match the setting value for the medium feeding unit 120 set by the user interface unit 150 (or a setting value set by the host device 300 which will be described later), the post-processing device 200 may determine a width control instruction based on one of the inferred information and the setting value according to a preset priority.

In addition, the second control unit 280 of the post-processing device 200 may set the width of the medium alignment unit 220 to be slightly wider than the width of the printing medium in consideration of the determined type of printing medium. This is to facilitate an alignment operation of the tempers and the width information of the medium alignment unit 220 may be preset for different types of printing media.

After printing is completed, the second control unit 280 controls the post-processing unit 210 to perform post-processing for the printing media stacked on the stacker 241. A plurality of printing media corresponding to the print instruction can be stacked on the stacker 241 and the post-processing unit 210 may perform post-processing for the plurality of printing media stacked on the stacker 241.

Although it has been illustrated in the embodiment as shown in FIG. 3 that the image forming apparatus 100 and the post-processing device 200 have their respective control units 180 and 280 and the image forming and post-processing operations are performed through information exchange between the control units, the control unit 180 of the image forming apparatus 100 may control the operation of the post-processing device 200 as necessary. If the post-processing device 200 is incorporated into the image forming apparatus 100, the first control unit 180 may control the operations of the post-processing unit 210, the medium alignment unit 220, the second conveying unit 230 and the second discharging unit 240.

The image forming system shown in FIG. 3 may further include the host device 300 which can be connected to the image forming apparatus 100.

The host device 300 may be implemented by a personal computer (PC) which can be connected to the image forming apparatus, and includes an image processing unit 310, a third input unit 351, a third display unit 352, a third storage unit 360, a third communication unit 370 and a third control unit 370.

The image processing unit 310 generates print data by performing an image processing operation using a predetermined print language such as PS, PCL or the like according to a print instruction. Specifically, upon receiving a print instruction from a user, the image processing unit 310 calls a printer driver or an application which can be in interlock with the printer driver, generates print data by performing rendering and/or halftoning operations for a print-targeted document, and performs a spooling operation for the generated print data. The spooled print data are transmitted to the image forming apparatus 100 via the third communication unit 370.

The third input unit 351 receives an instruction from the user. The third input unit 351 includes an input means such as a key board and a mouse and may further include a graphics user interface (GUI) to be displayed on the third display unit 352, which is generated by execution of a printer driver or a separate application to allow a user to input an instruction.

The user may perform a setting for the medium feeding unit 120 of the image forming apparatus 100 using the third input unit 151.

For example, if the medium feeding unit 120 includes a multipurpose cassette as a paper feeding tray, the user may execute the printer driver and input a setting value (for example, A4) to set the type of printing media stacked on the multipurpose cassette by manipulating the third input unit 351 in correspondence to a screen displayed on the third display unit 352. The setting value input through the third input unit 351 is transmitted to the image forming apparatus 100 via the third communication unit 370. Thus, the setting operation is completed.

The user may manipulate the third input unit 351 to input a print instruction for a document. In this embodiment, the print instruction may include a post-processing option. That is, when a printing operation is performed using the host device 300, the user may select one of the first discharging unit 140 of the image forming apparatus 100 and the second discharging unit 240 of the post-processing device 200 to which the document is output. In addition, if the user selects the second discharging unit 240 of the post-processing unit 200, a size of printing medium can be set.

In addition, the user may perform a log-in procedure to input his/her assigned ID and password through the third input unit 351. Here, the log-in includes a log-in of an administrator mode which may be set and modified for all configurations of the image forming apparatus 100 without separate access restriction. When the user's log-in or administrator mode log-in procedure is performed, the host device 300 transmits the input log-in information to the image forming apparatus 100 and then the image forming apparatus 100 performs an identification and authentication procedure for this log-in.

The third display unit 352 may display setting and operation states of the image forming apparatus 100, which are received via the third communication unit 370, to the user and may display a GUI screen for reception of various instructions from the user.

The third display unit may be implemented by a monitor including a thin film transistor-liquid crystal display (TFT-LCD) and a driving unit (not shown) which can drive the TFT-LCD.

The third storage unit 360 stores job object files, a driver for communication with the image forming apparatus 100, application information, etc. Examples of the third storage unit 360 may include an internal storage medium such as HDD, and an external or portable storage medium such as a USB memory and a memory card (memory stick, compact flash (CF) card, multimedia card (MMC), etc.).

The third communication unit 370 performs data communication with an external apparatus including the image forming apparatus 100. Examples of the third communication unit 370 may include a wired/wireless communication module which can be connected to the external apparatus by network using a predetermined protocol, a communication interface such as a universal asynchronous receiver transmitter (UART) or a universal serial bus (USB), however, it is not limited thereto.

The third control unit 370 may control the entire operation of the host device 300. Specifically, the third control unit 370 receives a setting value for the medium feeding unit 120, which is input through the third input unit 351, stores the received setting value in the third storage unit 360, and controls the third communication unit 370 to transmit the input setting value to the image forming apparatus 100.

Upon receiving an instruction including a post-processing option, the image forming apparatus 100 controls the width of the medium alignment unit 220 to correspond to the setting value of the medium feeding unit 120 which is received from the host device 300.

A setting value for the medium feeding unit 120 which is set through the user interface unit 150 of the image forming apparatus 100 or through the input unit 351 of the host device 300 may be set independent of a printing operation for print data and a post-processing operation.

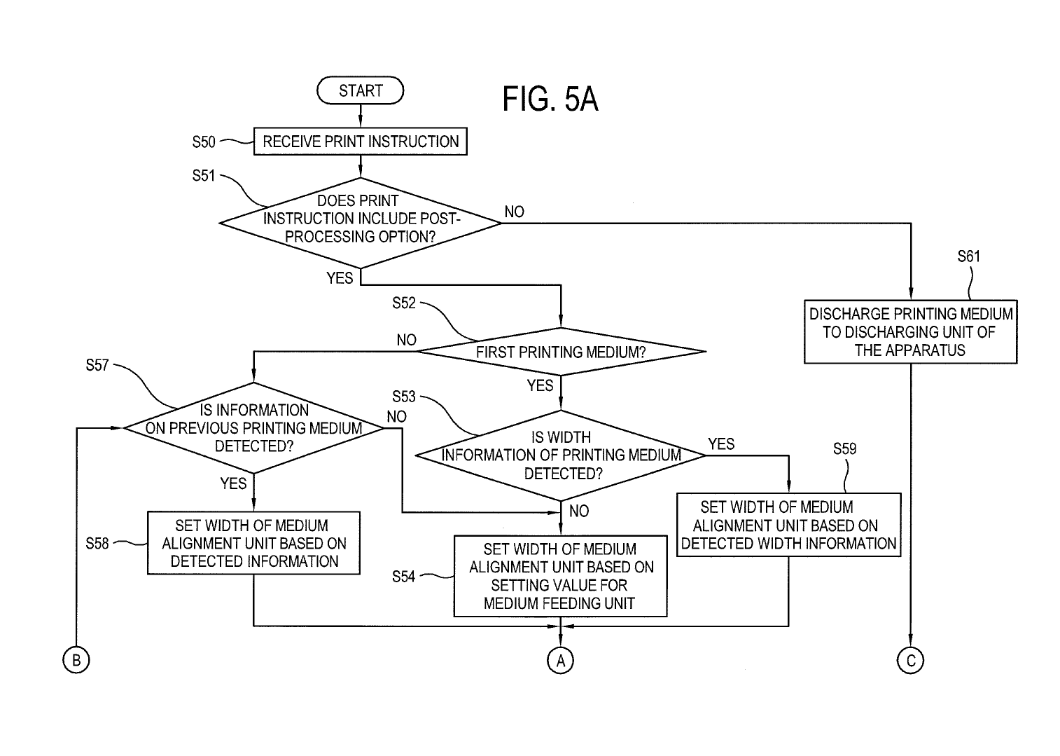

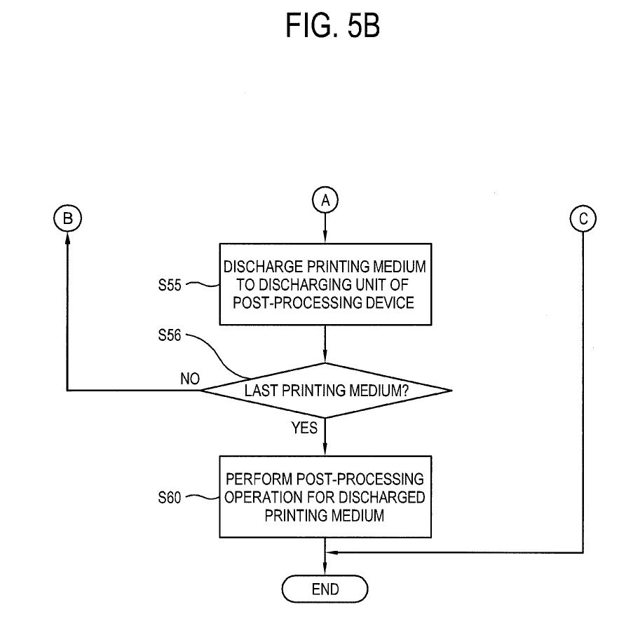

Hereinafter, a control method the image forming apparatus as configured above will be described with reference to FIGS. 5A and 5B.

FIGS. 5A and 5B illustrate a control method of an image forming apparatus according to one exemplary embodiment of the present invention.

As shown in FIG. 5A, the image forming apparatus receives a print instruction and performs a printing operation based on the print instruction (S50).

The first control unit 180 determines whether the print instruction received in operation S50 includes a post-processing option (S51).

If it is determined in operation S51 that the print instruction includes the post-processing option, the first control unit 180 determines whether a printing medium being conveyed corresponds to the first printing medium corresponding to the print instruction in operation S50 (S52).

If it is determined in operation S52 that the printing medium being conveyed is the first printing medium, the first control unit 180 determines whether width information of the printing medium to be printed is detected (S53). In this embodiment, whether the width information is detected may be determined by the presence or not of a sensor within the medium feeding unit 120, i.e., a paper feeding tray. In other words, a medium feeding unit 120 having no size sensor, such as a multipurpose cassette, can not detect the width information of the printing medium.

If it is determined in operation S53 that the width information of the printing medium is not detected, the first control unit 180 sets a width of the medium alignment unit 220 based on a setting value for the medium feeding unit 120 which feeds the printing medium for the print instruction in operation S50. In this embodiment, the setting value for the medium feeding unit 120 may be set through the user interface unit 150 of the image forming apparatus 100 or through the input unit 351 of the host device 300 connected to the image forming apparatus 100.

As shown in FIG. 5B, the image forming apparatus 100 receives the printing medium from the medium feeding unit 120 according to the print instruction in operation S50, conveys the received printing medium along the conveying path P2, and discharges the conveyed printing medium to the second discharging unit 240 of the post-processing device 200 (S55). In this embodiment, the width of the medium alignment unit 220, i.e., the tempers, is controlled based on the setting value set in operation S54 to align the discharged printing medium. Specifically, the tempers temporarily load and cool printed and discharged printing media, align the predetermined number of printing media accumulated in the tempers, and put the aligned printing media on the stacker 241 at the bottom of the tempers.

The first control unit 180 determines whether the printing medium discharged in operation S55 is the last printing medium for the print instruction (S56).

If it is determined in operation S56 that the printing medium is not the last printing medium, the first control unit 180 determines whether information on a previous printing medium (for example, the first printing medium if the current printing medium is the second printing medium) is detected (S57). In this embodiment, the information on the previous printing medium becomes length information of the printing medium based on time information detected by a sensor placed on the conveying path. The first control unit 180 may calculate the length of the printing medium using the detected time information and infer the width of the printing medium based on the calculated length.

If it is determined in operation S57 that the information on the printing medium is detected by the sensor placed on the conveying path, the first control unit 180 sets the width of the medium alignment unit 220 based on the information detected in operation S56 (S58).

Next, the image forming apparatus 100 conveys the printing media and the post-processing device 200 aligns the printing media based on the setting value set in operation S58 and discharges the aligned printing media to the second discharging unit 240 of the post-processing device 200 (S55).

If it is determined in operation S57 that the information on the printing medium is not detected, the first control unit 180 sets the width of the medium alignment unit 220 based on the setting value for the medium feeding unit 120, like the first printing medium (S54). In this embodiment, no detection of the information on the printing medium may include the absence of sensor on the conveying path or a malfunction of the sensor.

If it is determined in operation S53 that the width information of the printing medium is detected, i.e., if the medium feeding unit 120 includes a size sensor, the first control unit 180 sets the width of the medium alignment unit 220 based on the width information detected in operation S53 (S59).

In this embodiment, if the medium feeding unit 120 includes the size sensor and if the information detected by the size sensor, the printing medium information inferred through the sensor placed on the conveying path of the image forming apparatus 100 and the setting value set by the user interface unit 150 or the host device 300 are different from each other, the post-processing device 200 may be implemented to determine an instruction to control the width based on one of the three different values according to a preset priority.

Then, the image forming apparatus 100 conveys the printing medium and the post-processing device 200 aligns the printing media based on the setting value set in operation S59 and discharges the aligned printing media to the second discharging unit 240 of the post-processing device 200 (S55).

If it is determined in operation S56 that the printing medium is the last printing medium, the post-processing device 200 performs a post-processing operation for the printing medium corresponding to the print instruction in operation S50 (S60). In this embodiment, the printing medium may be provided in plural to be post-processed, and a plurality of printing media may be aligned by the medium alignment unit 220 for facilitation of post-processing.

If it is determined in operation S51 that the print instruction does not include the post-processing option, the image forming apparatus 100 conveys the printing medium along the conveying path P1 and discharges the conveyed printing medium to the first discharging unit 140 of the image forming apparatus 100 (S61).

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. An image forming apparatus including a post-processing device which performs a post-processing operation for a discharged printing medium with an image formed thereon, comprising:
an image forming unit which forms an image on the printing medium;
a medium feeding unit which feeds the printing medium to the image forming unit;
a discharging unit which is provided in the post-processing device and discharges the printing medium with the image formed thereon;
a medium alignment unit which aligns the printing medium for post-processing for the discharged printing medium;
a user interface unit which receives an instruction from a user; and
a control unit which controls a width of the medium alignment unit to correspond to a width of the discharged printing medium based on a setting value for the medium feeding unit, which is input through the user interface unit, if the size of the printing medium loaded on the medium feeding unit is not detected.

2. The image forming apparatus according to claim 1, wherein the medium alignment unit comprises a pair of tempers which are spaced by a predetermined distance from each other, and
wherein the control unit controls the width between the pair of tempers based on a setting value for the type of printing medium for the medium feeding unit, which is input through the user interface unit.

3. The image forming apparatus according to claim 1, further comprising a conveying unit which conveys the printing medium fed from the medium feeding unit and comprises a sensor which detects the conveyed printing medium,
wherein the control unit controls the width of the medium alignment unit using a sensing value of the sensor.

4. The image forming apparatus according to claim 3, wherein the control unit controls the width of the medium alignment unit for second and subsequent printing media using the sensing value of the sensor which is detected for a first printing medium of a plurality of printing media.

5. The image forming apparatus according to claim 1, wherein the medium feeding unit comprises a multipurpose cassette.

6. An image forming apparatus which can be connected to a post-processing device which performs a post-processing operation for a discharged printing medium with an image formed thereon and includes a discharging unit which discharges the printing medium with the image formed thereon and a medium alignment unit which aligns the printing medium for post-processing for the discharged printing medium, comprising:
a communication unit which performs communication with the post-processing device;
an image forming unit which forms an image on the printing medium;
a medium feeding unit which feeds the printing medium to the image forming unit;
a user interface unit which receives an instruction from a user; and
a control unit which controls the communication unit to transmit an instruction to control a width of the medium alignment unit to correspond to a width of the printing medium discharged through the post-processing device to the post-processing device based on a setting value for the medium feeding unit, which is input through the user interface unit, if the size of the printing medium loaded on the medium feeding unit is not detected.

7. The image forming apparatus according to claim 6, wherein the medium alignment unit comprises a pair of tempers which are spaced by a predetermined distance from each other, and
wherein the control unit controls the width between the pair of tempers based on a setting value for the type of printing medium for the medium feeding unit, which is input through the user interface unit.

8. The image forming apparatus according to claim 6, further comprising a conveying unit which conveys the printing medium fed from the medium feeding unit and comprises a sensor which detects the conveyed printing medium,
wherein the control unit controls the width of the medium alignment unit using a sensing value of the sensor.

9. The image forming apparatus according to claim 6, wherein the control unit controls the width of the medium alignment unit for second and subsequent printing media using the sensing value of the sensor which is detected for a first printing medium of a plurality of printing media.

10. An image forming apparatus which is connected to a host device and includes a post-processing device which performs a post-processing operation for a discharged printing medium with an image formed thereon, comprising:
an image forming unit which forms an image on the printing medium;
a medium feeding unit which feeds the printing medium to the image forming unit;
a discharging unit which is provided in the post-processing device and discharges the printing medium with the image formed thereon;
a medium alignment unit which aligns the printing medium for post-processing for the discharged printing medium;
and
a control unit which controls a width of the medium alignment unit to correspond to a width of the discharged printing medium based on a setting value for the medium feeding unit, if the size of the printing medium loaded on the medium feeding unit is not detected.

11. The image forming apparatus according to claim 10, further comprising a communicating unit which receives the setting value for the medium feeding unit from the host unit.

12. The image forming apparatus according to claim 11, wherein the medium alignment unit comprises a pair of tempers which are spaced by a predetermined distance from each other, and
wherein the control unit controls the width between the pair of tempers based on a setting value for the type of printing medium for the medium feeding unit, which is received through the communication unit.

13. The image forming apparatus according to claim 10, further comprising a conveying unit which conveys the printing medium fed from the medium feeding unit and comprises a sensor which detects the conveyed printing medium,
wherein the control unit controls the width of the medium alignment unit using a sensing value of the sensor.

14. The image forming apparatus according to claim 12, wherein the control unit controls the width of the medium alignment unit for second printing media using the sensing value of the sensor which is detected for a first printing medium of a plurality of printing media.

15. The image forming apparatus according to claim 10, wherein the medium feeding unit comprises a multipurpose cassette.

16. An image forming apparatus which can be connected to a host device and a post-processing device which performs a post-processing operation for a discharged printing medium with an image formed thereon and includes a discharging unit which discharges the printing medium with the image formed thereon and a medium alignment unit which aligns the printing medium for post-processing for the discharged printing medium, comprising:
an image forming unit which forms an image on the printing medium;
a medium feeding unit which feeds the printing medium to the image forming unit;
a communication unit which performs communication with the post-processing device and the host device and receives a setting value for the medium feeding unit from the host device or a user; and
a control unit which controls the communication unit to transmit an instruction to control a width of the medium alignment unit to correspond to a width of the printing medium discharged through the post-processing device to the post-processing device based on the setting value for the medium feeding unit, which is received through the communication, when the size of the printing medium loaded on the medium feeding unit is not detected.

17. The image forming apparatus according to claim 15, wherein the medium alignment unit comprises a pair of tempers which are spaced by a predetermined distance from each other, and
wherein the control unit controls the width between the pair of tempers based on a setting value for the type of printing medium for the medium feeding unit, which is input through the user interface unit.

18. The image forming apparatus according to claim 15, further comprising a conveying unit which conveys the printing medium fed from the medium feeding unit and comprises a sensor which detects the conveyed printing medium,
wherein the control unit controls the width of the medium alignment unit using a sensing value of the sensor.

19. The image forming apparatus according to claim 17, wherein the control unit controls the width of the medium alignment unit for second printing media using the sensing value of the sensor which is detected for a first printing medium of a plurality of printing media.

20. A control method of an image forming apparatus which performs a post-processing operation for a discharged printing medium with an image formed thereon and includes a medium alignment unit which aligns the printing medium for post-processing for the discharged printing medium, comprising:
inputting a setting value for a medium feeding unit which feeds a printing medium;
receiving a print instruction and/or a post-processing option; and
controlling a width of the medium alignment unit to correspond to a width of the discharged printing medium with the image formed thereon based on the setting value for the medium feeding unit, when the size of the printing medium loaded on the medium feeding unit is not detected.

21. The control method according to claim 19, wherein the inputting a setting value for a medium feeding unit comprises using one of a user interface unit provided in the image forming apparatus and an input unit of a host device which can be connected to the image forming apparatus.

22. The control method according to claim 20, wherein the medium alignment unit comprises a pair of tempers which are spaced by a predetermined distance from each other,
wherein the inputting a setting value for a medium feeding unit comprises inputting a setting value for the type of printing medium for the medium feeding unit, and
wherein the controlling a width of the medium alignment unit comprises controlling the width between the pair of tempers based on the input setting value.

23. The control method according to claim 19, further comprising:
detecting a first printing medium of a plurality of printing media through a sensor placed on a conveying path of the printing medium; and
controlling the width of the medium alignment unit for second printing media using the detected sensing value.

24. The control method according to claim 19, wherein the medium feeding unit comprises a multipurpose cassette.

25. A control method of an image forming apparatus which performs a post-processing operation for a discharged printing medium with an image formed thereon and includes a medium alignment unit which aligns the printing medium for post-processing for the discharged printing medium, comprising:
setting a value for a medium feeding unit which feeding a printing medium; and controlling a width of the medium alignment unit to correspond to a width of the discharged printing medium with the image formed thereon based on the setting value for the medium feeding unit.

26. The control method according to claim 25, wherein the setting value is set by at least one of a user interface unit provided in the image forming apparatus and an input unit of a host device which can be connected to the image forming apparatus.

27. A control method of an image forming apparatus which performs a post-processing operation for a discharged printing medium with an image formed thereon and includes a medium alignment unit which aligns the printing medium for post-processing for the discharged printing medium, comprising:
determining a value to adjust a width of a medium alignment unit;
adjusting the width of the medium alignment unit for post-processing based on the adjusted value.

28. The control method according to claim 27, wherein the adjusted value is set by at least one of a user interface unit provided in the image forming apparatus and an input unit of a host device which can be connected to the image forming apparatus.
